(19) United States
(12) Patent Application Publication
(10) Pub. No.: US 2008/0026772 A1
(43) Pub. Date: Jan. 31, 2008

(54) MOBILE COMMUNICATION SYSTEM UTILIZING GPS DEVICE AND HAVING GROUP COMMUNICATION CAPABILITY

(76) Inventors: Shin-Wen Chang, Taipei City (TW); Ya-Ran Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/750,312

(22) Filed: May 17, 2007

(30) Foreign Application Priority Data
Jul. 27, 2006 (TW) 095127531

(51) Int. Cl. H04Q 7/20

(52) U.S. Cl. 455/456.1

(57) ABSTRACT

A mobile communication system is disclosed. The mobile communication system includes a first communication module, wherein the first communication module includes a first global positioning device utilized for determining a coordinate of the first communication module; a first communication apparatus, coupled to the first global positioning device, for receiving a coordinate of a second communication module; a first operating interface; and a first processing circuit, coupled to the first communication apparatus and the first operating interface, for controlling the first operating interface to indicate a position of the first communication module according to the coordinate of the first communication module or controlling the first operating interface to indicate a position of the second communication module according to the coordinate of the second communication module.

### BACKGROUND OF THE INVENTION

1. Field of the Invention

The present invention relates to a mobile communication system, and more particularly, to a mobile communication system, applied in a Global Positioning System (GPS), having group communication capability for displaying positions of communication members in a group.

2. Description of the Prior Art

Currently, with development of the Global Positioning System (GPS), related global positioning devices have seen various applications both in public life (e.g. mountain climbing, traveling, personal navigation, and vehicle navigation) and in business (e.g. fishing) although the global positioning devices were initially designed for military purposes (e.g. ship positioning, aircraft positioning, and missile navigation). Generally speaking, a global positioning device is integrated with electronic maps while being applied in a vehicle navigation system. The global positioning device is utilized for displaying a current position of a vehicle on the electronic map, and for informing the vehicle driver of better driving paths between a starting point and a destination so the vehicle driver can successfully arrive at their destination. As mentioned above, in current applications only the position of the vehicle being driven by the vehicle driver is displayed on the electronic map.

With better living standards, car travel with relatives and friends becomes more popular. When traveling in convoy it is not uncommon for vehicles to become separated. Usually, if one vehicle is missing, other vehicle drivers will use mobile phones to contact the driver or passengers of the missing vehicle to determine current positions of the respective vehicles and to decide a new meeting place. This method of communicating is not particularly effective. For example, if the driver and passengers of the missing vehicle are unfamiliar with the local environment, they will only have the option of a well-known landmark or a famous scenic spot in the local environment as a meeting place. Furthermore, even if all drivers are familiar with the local environment it is possible for communication misunderstanding to occur when determining a new meeting location. Additionally, if this method of communication is used, it will likely result in one party (e.g. persons in the missing vehicle or persons in the other vehicles) waiting for the other party at the meeting place. This will extend the overall journey time. For these reasons, if the vehicle navigation system is able to provide users with a function enabling them to view all vehicles on the electronic map on a display screen and also to communicate with persons in another vehicle, all the above-mentioned problems can be solved since the time wasted by misunderstandings and one party waiting for the other party can both be saved.

### SUMMARY OF THE INVENTION

Therefore one of the objectives of the present invention is to provide a mobile communication system having group communication capability, applied in a GPS for displaying positions of members in a group, to solve the above-mentioned problem.

According to the claimed invention, a mobile communication system is disclosed. The mobile communication system comprises a first communication module, wherein the first communication module comprises a first global positioning device, a first communication apparatus, a first processing circuit, and a first operating interface. The first global positioning device is utilized for determining a coordinate of the first communication module. The first communication apparatus is coupled to the first global positioning device and utilized for receiving a coordinate of a second communication module. The first processing circuit is coupled to the first communication apparatus and the first operating interface, and is utilized for controlling the first operating interface to indicate a position of the first communication module according to the coordinate of the first communication module or controlling the first operating interface to indicate a position of the second communication module according to the coordinate of the second communication module.

According to the claimed invention, a mobile communication method is disclosed. The mobile communication method comprises: utilizing a global positioning system to determine a coordinate of a first communication module; receiving a coordinate of a second communication module; providing a first operating interface; and controlling the first operating interface to indicate a position of the first communication module according to the coordinate of the first communication module or to indicate a position of the second communication module according to the coordinate of the second communication module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a mobile communication system according to an embodiment of the present invention.

FIG. 2 is a simplified diagram of a navigation display shown by the first operating interface shown in the FIG. 1.

FIG. 3 is a simplified diagram of a communication display shown by the first operating interface shown in FIG. 1.

### DETAILED DESCRIPTION

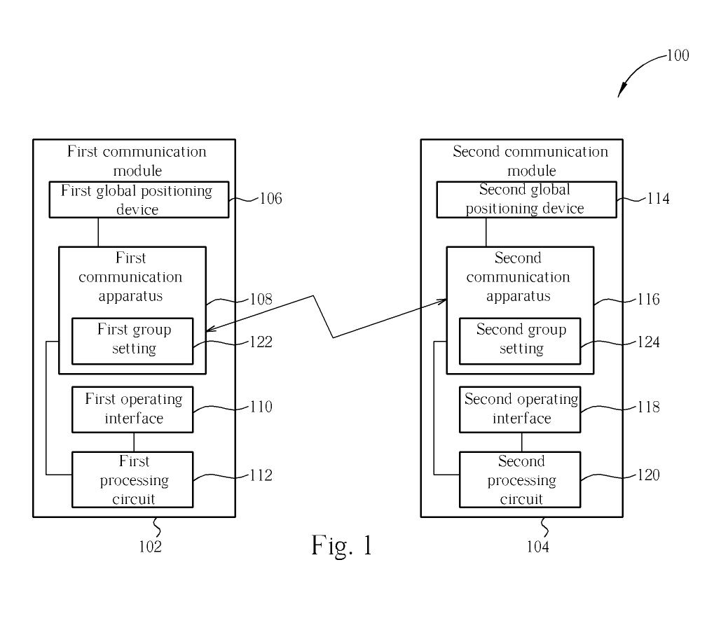

Please refer to FIG. 1. FIG. 1 is a diagram of a mobile communication system 100 according to an embodiment of the present invention. As shown in FIG. 1, the mobile communication system 100 comprises at least a first communication module 102 and a second communication module 104. In FIG. 1, the first communication module 102 and the second communication module 104 are only shown for brevity. However, the number of the communication modules is not a limitation of the present invention. The first communication module 102 comprises a first global positioning device 106, a first communication apparatus 108, a first operating interface 110, and a first processing circuit 112. The second communication module 104 comprises a second global positioning device 114, a second communication apparatus 116, a second operating interface 118, and a second processing circuit 120. In addition, in this embodiment, the first communication apparatus 108 comprises a first group setting 122, and the second communication apparatus 116 comprises a second group setting 124. The first group setting 122 is utilized for defining at least a communication member of the first communication module 102, and the second group setting 124 is utilized for defining at least a communication member of the second communication module 104. The first global positioning device 106 and the second global positioning device 114 receive positioning signals transmitted from a plurality of satellites to determine coordinates of the first communication module 102 and the second communication module 104 respectively. The first communication apparatus 108 transmits the coordinate of the first communication module 102 determined by the first global positioning device 106 to corresponding communication members (i.e. the communication members in the same group) and receives the coordinates transmitted from the corresponding communication members (i.e. the communication members in the same group). Similarly, the second communication apparatus 116 transmits the coordinate of the second communication module 104 determined by the second global positioning device 114 to corresponding communication members (i.e. the communication members in the same group) and receives the coordinates transmitted from the corresponding communication members (i.e. the communication members in the same group). The first operating interface 110/second operating interface 118 is utilized for displaying positions of the first communication module 102/second communication module 104 and corresponding communication members in an electronic map, and can also be controlled by users to inform its corresponding communication members of changing positions in response to their changed positions if necessary. Additionally, the first operating interface 110/second operating interface 118 has a push-to-talk mode for establishing a communication between the first communication module 102/second communication module 104 and its communication members. In the push-to-talk mode, a communication function is added into the first communication module 102/second communication module 104. It is convenient for users to use the first communication module 102/second communication module 104 to communicate with the corresponding communication members directly. The first processing circuit 112/second processing circuit 120 controls the first operating interface 110/second operating interface 118 to indicate positions of the first communication module 102/second communication module 104 according to the coordinates of the first communication module 102/second communication module 104.

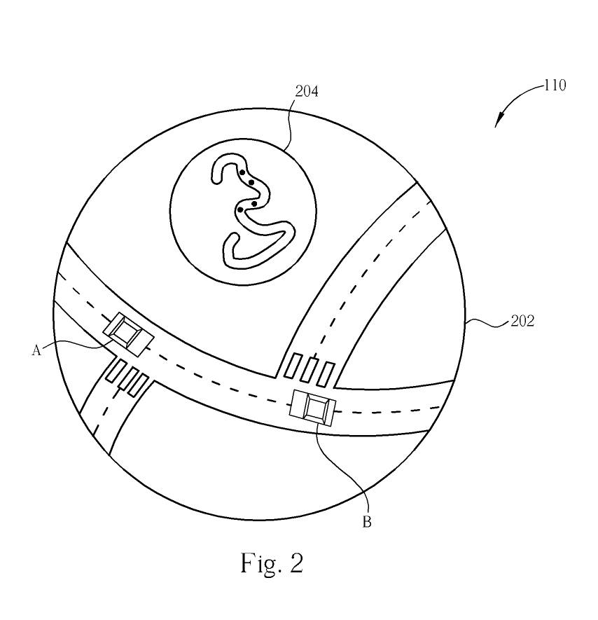

In this embodiment, the first communication module 102 and the second communication module 104 are applied in vehicle navigation products. The first communication module 102 and the second communication module 104 can also be applied in personal navigation products or any kind of navigation products; this is not a limitation of the present invention. The first communication module 102 and the second communication module 104 are assumed to be in the same group. In other words, the first communication module 102 and the second communication module 104 are communication members to each other. A short message in a conventional mobile phone communication system (e.g. a Global System for Mobile (GSM) communication system or a General Packet Radio Service (GPRS) communication system) is utilized for transmitting the coordinate of the first communication module 102 to the second communication module 104 or transmitting the coordinate of the second communication module 104 to the first communication module 102. Therefore, in the first group setting 122, the second communication module 104 is defined as a communication member of the first communication module 102. Similarly, in the second group setting 124, the first communication module 102 is defined as a communication member of the second communication module 104. The first communication apparatus 108 transmits the coordinate of the first communication module 102 to the second communication apparatus 116 in the second communication module 104 via a short message, and receives a short message, comprising information related to the coordinate of the second communication module 104, transmitted from the second communication apparatus 116 in the second communication module 104. The first processing circuit 112 can control the first operating interface 110 to indicate the positions of the first communication module 102 and its communication member in an electronic map respectively according to the coordinates of the first communication module 102 and its communication member (i.e. the second communication module 104). Please refer to FIG. 2. FIG. 2 is a simplified diagram of a navigation display shown by the first operating interface 110 shown in the FIG. 1. As shown in FIG. 2, the navigation display comprises a primary display area 202 and a secondary display area 204. The positions of the communication modules belonging to the same group will be displayed on the primary display area 202. For example, if four vehicles shown in FIG. 2 all belong to a group and two of the vehicles are equipped with the first communication module 102 and the second communication module 104 respectively, a position A of the first communication module 102 and a position B of the second communication module 104 in the electronic map will be displayed on the primary display area 202. Additionally, an order and positions of communication modules belonging to the same group in a predetermined path will be displayed on the secondary display area 204. In FIG. 2, for example, the order and positions of four vehicles are displayed on the secondary display area 204 since the vehicles equipped with the above-mentioned communication modules all belong to the same group.

In addition to displaying the positions of the first communication module 102 and its communication members, the first operating interface 110 can also be controlled by users (e.g. a vehicle driver or another passenger) to inform its communication members of changing positions via a short message in response to their changed positions if need be. For example, if the vehicle driver considers the distance between the vehicle driven by him and other vehicles belonging to the same group to be too large, he can inform the other vehicles belonging to the same group to decrease the distance between the vehicles through the first operating interface 110. Additionally, when the vehicle driver is driving, the first operating interface 110 also helps the vehicle driver to communicate with persons in other vehicles conveniently as the first operating interface 110 has a push-to-talk mode (in which users can communicate with persons in other vehicles by directly pressing one button instead of inputting phone numbers one by one).

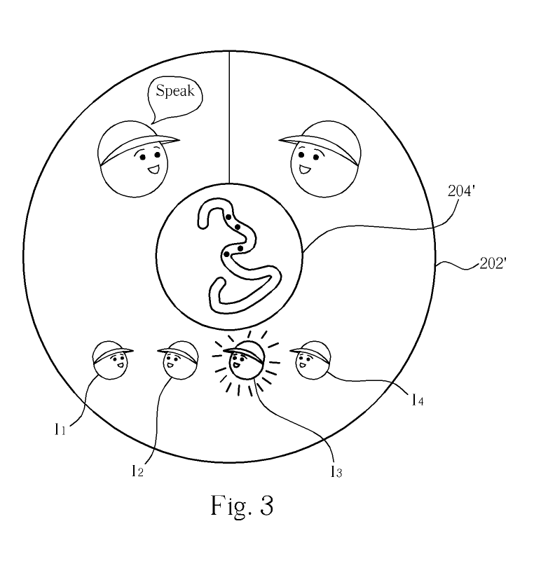

That is, if communicating with persons in other vehicles is desired, the vehicle driver can use the push-to-talk mode to directly dial phone numbers related to the communication members defined in the first group setting 122 for establishing communication. The push-to-talk mode also supports accepting requested calls of persons in other vehicles for establishing communication. Please refer to FIG. 3. FIG. 3 is a simplified diagram of a communication display shown by the first operating interface 110 shown in FIG. 1. As shown in FIG. 3, the communication display comprises a primary display area 202′ and a secondary display area 204′. The order and positions of the communication modules belonging to the same group (i.e. the above-mentioned four vehicles in the same group) in the predetermined path will be displayed on the secondary display area 204′ as well as the secondary display area 204. The icons I₁, I₂, I₃, and I₄, representative of different communication members in the same group, are displayed on the primary display area 202′. For accomplishing the push-to-talk mode, in this embodiment, a user can press (or select) the icon 13 in the primary display area 202′ or the corresponding vehicle icon in the secondary display area 204′ to establish a communication immediately if communicating with the communication member corresponding to the icon 13 is desired. After pressing or selecting the icon 13, the icons corresponding to the user and the icon 13 will also be displayed on the upper half of the primary display area 202′.

Please note that any scheme for enabling the first operating interface 110 to control the first communication module 102 and its communication members (in this embodiment, its communication member is the second communication module 104) for communicating to each other, for example a touch control scheme, a keypress control scheme or an audio control scheme, also obeys the spirit of the present invention. Additionally, the function and operation of elements included in the second communication module 104 is similar to that included in the first communication module 102 since the names of the elements included in the second communication module 104 are similar to these included in the first communication module 102. Further description is therefore not detailed for brevity.

In another embodiment, the first communication apparatus 108 in the first communication module 102 does not receive coordinates transmitted from any communication member of the first communication module 102 (e.g. the second communication module 104) and only transmits the coordinate of the first communication module 102 to its communication members whether the function and operation of elements in the second communication module 104 is similar to that in the first communication module 102 or not. That is to say, the first communication module 102 is only utilized for informing other communication modules corresponding to communication members of the position of the first communication module 102. Therefore, the first operating interface 110 will only display the position of the first communication module 102 in the electronic map. However, the first communication module 102 can also be utilized for informing all communication modules of the position of the first communication module 102 even though some communication modules are not the communication members of the first communication module 102. Thus, the first communication apparatus 108 has to broadcast the coordinate of the first communication module 102 to all other communication apparatuses. This also falls within the scope of the present invention.

In other embodiments, the second communication apparatus 116 in the second communication module 104 only receives the coordinates transmitted from other communication modules (e.g. the first communication module 102) and never transmits the coordinate of the second communication module 104 to other communication modules whether the function and operation of elements in the first communication module 102 is similar to that in the second communication module 104 or not. That is to say, the second communication module 104 has no communication members, and the other communication modules, viewing the second communication module 104 as their communication member, do not know the coordinate of the second communication module 104. Therefore, for the second communication module 104, the positions of the second communication module 104 and the other communication modules which view the second communication module 104 as their communication member can be displayed on the second operating interface 118. However, it is also possible for other communication modules that do not view the second communication module 104 as their communication member to transmit their coordinates to the second communication module 104, which can receive these coordinates. Similarly, the positions of the communication modules that do not view the second communication module 104 as their communication member will also be displayed on the second operating interface 118. This also obeys the spirit of the present invention.

It should be noted that, in the above embodiments, although transmitting the coordinates of the communication modules and establishing the communication between the communication modules occurs via the conventional mobile communication system, transmitting the coordinates of the communication modules and establishing the communication between the communication modules can also be accomplished via Internet (e.g. wireless internet or wire internet). For example, transmitting the coordinates of the communication modules and establishing the communication between the communication modules can be accomplished by utilizing Internet addresses. This also falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile communication system, comprising:
a first mobile communication module, comprising:
a first global positioning device, for determining a coordinate of the first mobile communication module;
a first communication apparatus, coupled to the first global positioning device, for receiving a coordinate of a second mobile communication module;
a first operating interface; and
a first processing circuit, coupled to the first communication apparatus and the first operating interface, for controlling the first operating interface to indicate a position of the first mobile communication module according to the coordinate of the first mobile communication module or controlling the first operating interface to indicate a position of the second mobile communication module according to the coordinate of the second mobile communication module.

2. The mobile communication system of claim 1, wherein the first communication apparatus is a mobile phone.

3. The mobile communication system of claim 2, wherein the mobile phone receives the position of the second mobile communication module via a short message.

4. The mobile communication system of claim 3, wherein the mobile phone utilizes a Global System for Mobile communication (GSM) System or a General Packet Radio Service (GPRS) System to receive the short message.

5. The mobile communication system of claim 1, wherein the first communication apparatus is a wireless network apparatus.

6. The mobile communication system of claim 1, wherein the first mobile communication module comprises a first group setting for defining at least a communication member, and the first communication apparatus receives a coordinate of the communication member according to the first group setting, where the second mobile communication module is a communication member of the first mobile communication module and is positioned in the mobile communication system.

7. The mobile communication system of claim 6, wherein the first group setting comprises a phone number of the communication member.

8. The mobile communication system of claim 6, wherein the second mobile communication module comprises:
a second global positioning device, for determining a coordinate of the second mobile communication module; and
a second communication apparatus, coupled to the second global positioning device, for transmitting the coordinate of the second mobile communication module to the first mobile communication module.

9. The mobile communication system of claim 8, wherein the second communication apparatus comprises a second group setting for defining the first mobile communication module as a communication member, and the second communication apparatus transmits the coordinate of the second mobile communication module to the first mobile communication module according to the second group setting.

10. The mobile communication system of claim 9, wherein the first communication apparatus further transmits the coordinate of the first mobile communication module to the second mobile communication module, and the second mobile communication module further comprises:
a second operating interface; and
a second processing circuit, coupled to the second communication apparatus and the second operating interface, for controlling the second operating interface to indicate a position of the first mobile communication module according to the coordinate of the first mobile communication module or controlling the second operating interface to indicate a position of the second mobile communication module according to the coordinate of the second mobile communication module.

11. The mobile communication system of claim 1, wherein the first mobile communication module establishes a communication between the first mobile communication module and the second mobile communication module via the first operating interface by a push-to-talk mode.

12. A mobile communication method, comprising:
utilizing a global positioning system to determine a coordinate of a first mobile communication module;
receiving a coordinate of a second mobile communication module;
providing a first operating interface; and
controlling the first operating interface to indicate a position of the first mobile communication module according to the coordinate of the first mobile communication module or to indicate a position of the second mobile communication module according to the coordinate of the second mobile communication module.

13. The mobile communication method of claim 12, wherein the step of receiving the coordinate of the second mobile communication module complies with a specification of a mobile phone communication system.

14. The mobile communication method of claim 13, wherein the step of receiving the coordinate of the second mobile communication module is accomplished via a short message.

15. The mobile communication method of claim 14, wherein the mobile communication system is a Global System for Mobile (GSM) communication System or a General Packet Radio Service (GPRS) System.

16. The mobile communication method of claim 12, wherein the step of receiving the coordinate of the second mobile communication module complies with a specification of a wireless network.

17. The mobile communication method of claim 12, wherein the step of receiving the coordinate of the second mobile communication module comprises: setting a first group setting to define at least a communication member; and receiving a coordinate of the communication member according to the first group setting, where the second mobile communication module is a communication member of the first mobile communication module, and the first and second mobile communication modules are positioned in a mobile communication system.

18. The mobile communication method of claim 17, wherein the first group setting comprises a phone number of the communication member.

19. The mobile communication method of claim 17, further comprising:
utilizing the global positioning system to determine the coordinate of the second mobile communication module; and
transmitting the coordinate of the second mobile communication module to the first mobile communication module.

20. The mobile communication method of claim 19, further comprising:
setting a second group setting to define the first mobile communication module as a communication member; and
transmitting the coordinate of the second mobile communication module to the first mobile communication module according to the second group setting.

21. The mobile communication method of claim 20, further comprising:
transmitting the coordinate of the first mobile communication module to the second mobile communication module;
providing a second operating interface; and
controlling the second operating interface to indicate a position of the first mobile communication module according to the coordinate of the first mobile communication module or to indicate a position of the second mobile communication module according to the coordinate of the second mobile communication module.

22. The mobile communication method of claim 12, further comprising:
establishing a communication between the first mobile communication module and the second mobile communication module via the first operating interface by a push-to-talk mode.
